(19) United States
(12) Patent Application Publication
(10) Pub. No.: US 2008/0010255 A1
(43) Pub. Date: Jan. 10, 2008

(54) Method and apparatus for sharing content assets using picture transfer protocol

(75) Inventors: Sang-kwon Lee, Suwon-si (KR); Myoung-soon Choi, Suwon-si (KR); Seong-kook Shin, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/635,484

(22) Filed: Dec. 8, 2006

(30) Foreign Application Priority Data
Jul. 6, 2006 (KR) 10-2006-0063493
Aug. 18, 2006 (KR) 10-2006-0078138

(51) Int. Cl. G06F 17/30

(52) U.S. Cl. 707/3

(57) ABSTRACT

Provided is a method and apparatus for sharing content assets using a picture transfer protocol (PTP). The method, in which a first device shares a content asset of a second device, includes requesting for a content asset control file by transmitting an object identifier for the content asset to the second device; and receiving the content asset control file from the second device. Furthermore, in a method of providing a content asset included in a second device to a first device, the method includes receiving a request for a content asset control file from the first device; modifying the content asset control file by additionally recording object identifiers for respective object files included in the content asset to the content asset control file; and transmitting the modified content asset control file to the first device.

### CROSS-REFERENCE TO RELATED PATENT APPLICATION

This application claims priority from Korean Patent Application No. 10-2006-0063493, filed on Jul. 6, 2006, and Korea Patent Application No. 10-2006-0078138, filed on Aug. 18, 2006, in the Korean Intellectual Property Office, the disclosures of which are incorporated herein in their entirety by reference.

### BACKGROUND OF THE INVENTION

1. Field of the Invention

Apparatus and methods consistent with the present invention relate to sharing of content assets between systems, and more particularly, to a method and apparatus for sharing content assets using a picture transfer protocol (PTP).

2. Description of the Related Art

In general, when a digital camera shares a photo file with a personal computer (PC) or other devices, a universal serial bus (USB) cable is used for connection, and thereafter, the photo file is transferred using a picture transfer protocol (PTP). PTP is a standard protocol (ISO 15740) with which a photo taken by the digital camera can be transferred to other devices such as the PC or a printer using a USB, infrared data association (IrDA), or IEEE 1394. Meanwhile, cameras supporting album art such as music photo video (MPV) have been widely used in recent years instead of using a simple file list. The MPV is an open specification defined by optical storage technology association (OSTA). Contents such as digital music, photos, and motion pictures can be easily presented, exchanged, processed, and reproduced using MPV. However, since indexing and transferring can be achieved only in units of files under the conventional PTP, it is difficult to transfer album information.

FIG. 1 is a flow diagram of PTP, illustrating a file sharing operation between devices using PTP.

An initiator 130 opens a PTP session, and requests a responder 140 for various operations. A printer is a typical example of the initiator 130. The responder 140 responds to a PTP operation initiated by the initiator 130. A digital camera is an example of the responder 140. All types of files and folders included in a device, for example, photos, music, and motion pictures, are recognized as an object under PTP. ObjectInfo contains data object information. The data object information may include a file name, file format information (e.g., JPG, AVI), photo thumbnail information, and a modification date. In a device supporting PTP, an ObjectHandle is a 32-bit unsigned integer that is used to uniquely identify an object. Two PTP devices refer to the object by using the ObjectHandle. The ObjectHandle is maintained for at least one session. When an ObjectHandle is allocated to a file or a folder, any values can be used except for 0x00000000 and 0xFFFFFFFF.

The operations of the initiator 130 and the responder 140 will now be described with reference to FIG. 1. First, when the initiator 130 is connected to the responder 140 using USB (or IrDA, IEEE 1394, or RS232C), the initiator 130 requests device information from the responder 140 (operation S101). The responder 140 transmits the device information to the initiator 130 (operation S102). When the initiator 130 requests OpenSession( ) to be executed (operation S103), the responder 140 allocates various resources for a new session, and determines ObjectHandles for all objects stored in a storage (operation S103-1). As described above, all types of files and folders (e.g., photos, music, and motion pictures) which can be provided by the responder 140 are recognized as an object. An ObjectHandle for a ROOT directory must be 0, and the rest of the ObjectHandles depend on implementation. When the indicator 130 requests GetObjectHandles( ) to be executed (operation S104), the responder 140 provides ObjectHandle[1 to n] for all objects generated as described above (operation S105). The initiator 130 requests object information (ObjectInfo) required by the initiator 130 itself (operation S106). The responder 140 provides the requested object information (operation S107). The initiator 130 checks the received object information, and requests an object corresponding to the object information (operation S108). The responder 140 transmits the object to the initiator 130. After various necessary operations are carried out, the initiator 130 closes the session by calling CloseSession( ) (operation S110).

FIG. 2 illustrates an example of a directory structure of a digital camera when the digital camera (responder) is connected to a printer (initiator) by using PTP.

Referring to FIG. 2, the digital camera has two directories, a 100MODEL 210 and a 101MODEL 220. When OpenSession( ) is requested from the initiator 130, the responder 140 browses all files and folders included the digital camera, thereby allocating the ObjectHandles.

FIG. 3 illustrates an example of ObjectHandles 320 allocated to the directories and files of FIG. 2.

The ObjectHandles 320 have to uniquely identify respective objects. Any values can be used for the ObjectHandles 320 except for 0x00000000 (ROOT) and 0xFFFFFFFF. As shown in FIG. 1, the initiator 130 obtains an ObjectHandle list of all files from the responder 140. Thereafter, the initiator 130 uses an ObjectHandle to read a file required by the initiator 130 itself from the responder 140. For example, when the initiator 130 has to read a DSC0002.JPG file, by calling GetObject( ), the ObjectHandle is assigned with 4 as indicated by the reference number 330.

Meanwhile, an album is a sort of content asset, and is defined as a group of various contents such as photos, music, and motion pictures. A user may use the album so as to construct (organize), browse, and reproduce the contents by using a standardized method. An MPV album may include various media files (e.g., a still picture file, a video file, an audio file, and a text file) defined in MPV standard. Furthermore, another album may be provided by using ManifestLink. When two devices are connected using PTP, instead of an operation simply being performed in units of files, information can be browsed and copied in units of albums by using the MPV album. However, album information cannot be properly transmitted between devices when the conventional PTP protocol and the MPV album are used without modification.

FIG. 4 illustrates an example of a directory structure of a device having an MPV album.

In the example illustrated in FIG. 4, the photo files of FIG. 2 are configured as an MPV album. An MPV file has an extension .PVM. An INDEX.PVM 400 existing in a ROOT directory is a ROOT album file having a list of all the albums included in the device. Referring to FIG. 4, photo files existing in the 100MODEL folder 210 are gathered so as to form an ALBUM01.PVM 410, and photo files existing in the 101MODEL folder 220 are gathered so as to form an ALBUM02.PVM 420.

FIG. 5 illustrates an example in which ObjectHandles 520 are allocated to the directories, the albums, and the files of FIG. 4, indicated by the reference number 510. FIGS. 6, 7 and 8 respectively, illustrate examples of actual file structures of files of INDEX.PVM, ALBUM01.PVM, and ALBUM02.PVM. Referring to FIG. 6, the INDEX.PVM includes information 610 on the ALBUM01.PVM and information 620 on ALBUM02.PVM. Referring to FIG. 7, the ALBUM01.PVM includes information 710 on a DSC0001.JPG and information 720 on a DSC0002.JPG. Referring to FIG. 8, the ALBUM03.PVM includes information 810 on a DSC0003.JPG and information 820 on a DSC0004.JPG.

When a device having the album illustrated in FIG. 4 is connected to another device using PTP, the following problems have conventionally arisen.

First, an effective method has to be provided for better recognition of the MPV album. In the past, the following procedure was required in order for an initiator to recognize the INDEX.PVM file of a responder.

1. The initiator obtains device information on the responder.

2. The initiator opens a session, and the responder allocates ObjectHandles to respective files and folders.

3. The initiator requests all of the ObjectHandles.

4. The initiator sequentially calls GetObjectInfo( ) for the respective OjbectHandles, and checks whether an object file name is INDEX.PVM.

5. After the initiator finds INDEX.PVM, the initiator calls GetObject( ) and reads the INDEX.PVM file.

6. If the initiator cannot find INDEX.PVM, an album is deemed not to exist.

In the aforementioned album recognition process, a problem lies in that, in order to find the INDEX.PVM file, in a worst case scenario GetObjectInfo( ) has to be called as many times as the number of objects existing in the responder. When many files and folders exist in the responder, significant performance deterioration may occur in the process of finding the INDEX.PVM file. More seriously, since a file name included in the ObjectInfo does not contain path information, when many INDEX.PVM files exist in the responder, it is impossible to distinguish which object is the INDEX.PVM file existing in the ROOT directory.

Second, after the MPV album is recognized, contents cannot be browsed and transmitted in a unit of an album. After the INDEX.PVM file is found by means of the aforementioned processes, the initiator attempts to read assets (a media file or another album) included in the album. Information on an asset contained in the album is indicated as a <mpv:LastURL> element as shown in FIGS. 6 to 8. The element <mpv:LastURL> includes a relative path of a device if the asset exists in the device. When the asset does not exist in the device, the <mpv:LastURL> element is written in a URI format (for example, http://168.219.193.78/media/DSC0001.JPG). However, since information is transmitted/received between devices by using ObjectHandles using PTP, even if the initiator knows a relative path and a file name of the responder having the asset, there is no way to read a desired file. Therefore, two devices connected using PTP cannot properly process the MPV album.

In other words, PTP is developed so that a media file (e.g., a photo file) can be transmitted/received between two devices connected by the USB. Furthermore, a file is assigned irrespective of a file system by using the ObjectHandles. However, a content asset (e.g., an album) uses a path name or a URL contained in a file system in order to use a media file of the content asset or other content assets. Therefore, there is a difficulty recognizing the content asset between the two devices connected using PTP. Even if the content asset is recognized, contents included in the content asset cannot be properly transmitted.

### SUMMARY OF THE INVENTION

The present invention provides a method and apparatus in which content assets can be effectively shared between two devices connected using a picture transfer protocol (PTP) without modification to the standards of the conventional PTP and the content assets.

According to an aspect of the present invention, there is provided a method in which a first device shares a content asset of a second device, the method comprising: requesting a content asset control file by transmitting an object identifier for the content asset to the second device; and receiving the content asset control file from the second device.

The method may further comprise: requesting information on an object corresponding to the object identifier by transmitting the object identifier to the second device; receiving the object information from the second device; and determining whether the object is the content asset control file by analyzing the received object information, and deciding whether the content asset control file is requested according to the determination result.

The method may further comprise requesting an object identifier list from the second device if it is determined that the object is not the content asset control file.

The method may further comprise opening a picture transfer protocol (PTP) session with the second device before the object information is requested.

The content asset may be an Music Photo Video (MPV) ROOT album, and the object identifier may be 1.

The method may further comprise accessing a desired object file by using an object identifier, which is included in the received content asset control file, for the desired object file. The accessing of a desired object file may further comprise reading an object identifier for the desired object file from the received content asset control file; and requesting the desired object file or information on the desired object file by transmitting the read object identifier to the second device.

The received content asset control file may be an MPV album file including an <mpv:LastUrl> element for writing an object identifier for each object file included in the content asset. The <mpv:LastUrl> element may further comprise a file system identifier which indicates that the object identifier is written.

According to another aspect of the present invention, there is provided a method of providing a content asset included in a second device to a first device, the method comprising: receiving a request for a content asset control file from the first device; modifying the content asset control file by additionally recording an object identifier to the content asset control file for each object file included in the content assets; and transmitting the modified content asset control file to the first device.

The method may further comprise allocating an object identifier for an MPV ROOT album file corresponding to the content asset control file when a PTP session with the first device is opened. The object identifier may be 1.

The modifying of the content asset control file may further comprise inserting an <mpv:LastUrl> element including the object identifier for the each object file into the contents asset control file. The inserting of a <mpv:LastUrl> element may further comprise recording a file system identifier, which indicates that the <mpv:LastUrl> element writes the object identifier for the each object file, in the <mpv:LastUrl> element.

According to another aspect of the present invention, there is provided an apparatus for sharing a content asset of a second device, the apparatus comprising: a communication unit which communicates with the second device; a storage unit which stores an object identifier for the content asset; and a controller which receives a content asset control file through the communication unit by using the object identifier without having to request a list of all the object identifiers that can be provided by the second device.

An apparatus for providing a content asset to a first device is provided. The apparatus comprising: a communication unit which communicates with the first device; a storage unit which stores a content asset control file and one or more object files included in the content asset; and a controller which transmits the content asset control file through the communication unit after reading the content asset control file from the storage unit and modifying the content asset control file by additionally recording object identifiers for respective object files to the content asset control file when a request for the content asset control file is received from the first device through the communication unit.

### BRIEF DESCRIPTION OF THE DRAWINGS

The above and other features of the present invention will become more apparent by describing in detail exemplary embodiments thereof with reference to the attached drawings in which:

FIG. 1 is a flow diagram of picture transfer protocol (PTP);

FIG. 2 illustrates an example of a directory structure of a digital camera;

FIG. 3 illustrates an example of ObjectHandles allocated to the directories and files illustrated in FIG. 2;

FIG. 4 illustrates an example of a directory structure of a device having a music photo video (MPV) album;

FIG. 5 illustrates an example of ObjectHandles allocated to the directories, the albums, and the files illustrated in FIG. 4;

FIG. 6 illustrates an example of the INDEX.PVM file illustrated in FIG. 4;

FIG. 7 illustrates an example of the ALBUM01.PVM file illustrated in FIG. 4;

FIG. 8 illustrates an example of the ALBUM02.PVM file illustrated in FIG. 4;

FIG. 9 illustrates a structure of a first device and a second device sharing content assets according to an exemplary embodiment of the present invention;

FIG. 10 is a flowchart illustrating a method of sharing content assets of a first device and a second device according to an exemplary embodiment of the present invention;

FIG. 11 is a flowchart illustrating a method of recognizing a ROOT MPV album according to an exemplary embodiment of the present invention;

FIG. 12 is a flowchart illustrating a method of providing content assets from a second device to a first device according to an exemplary embodiment of the present invention;

FIG. 13 illustrates an example of a PTP flow for sharing an MPV album according to an exemplary embodiment of the present invention;

FIG. 14 illustrates an example of an INDEX.PVM file according to an exemplary embodiment of the present invention;

FIG. 15 illustrates an example of an ALBUM01.PVM file according to an exemplary embodiment of the present invention; and

FIG. 16 illustrates an example of an ALBUM02.PVM according to an exemplary embodiment of the present invention.

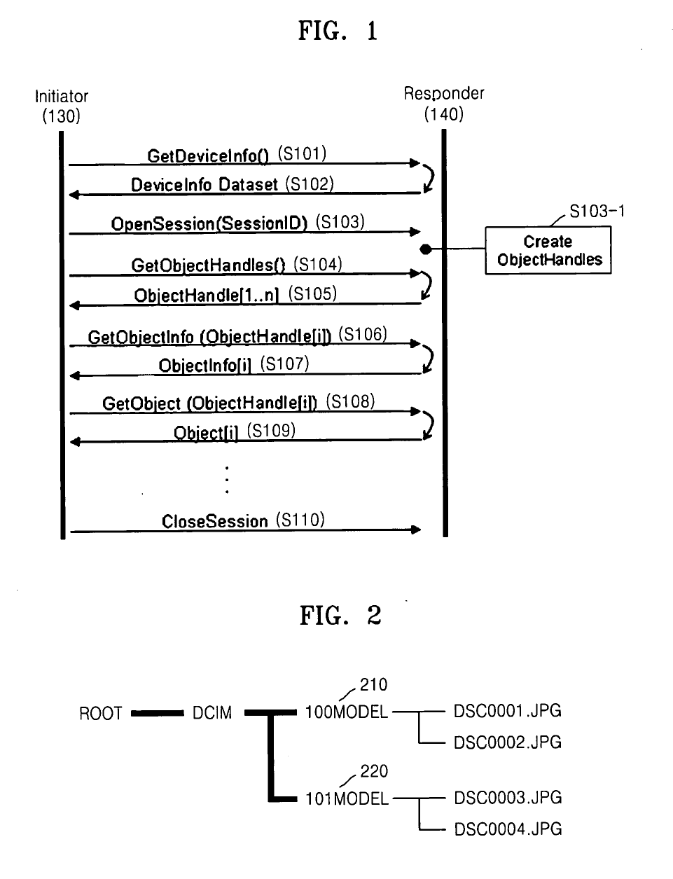

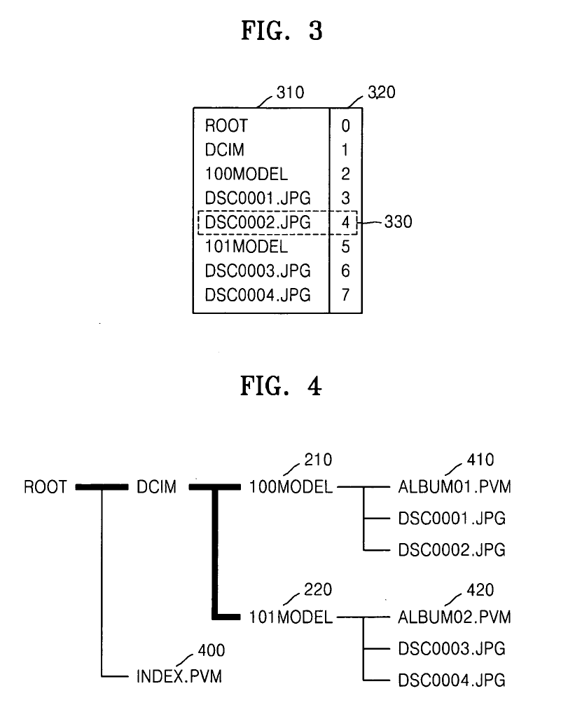

### DETAILED DESCRIPTION OF THE EXEMPLARY EMBODIMENTS OF THE INVENTION

Hereinafter, exemplary embodiments of the present invention will be described with reference to the accompanying drawings.

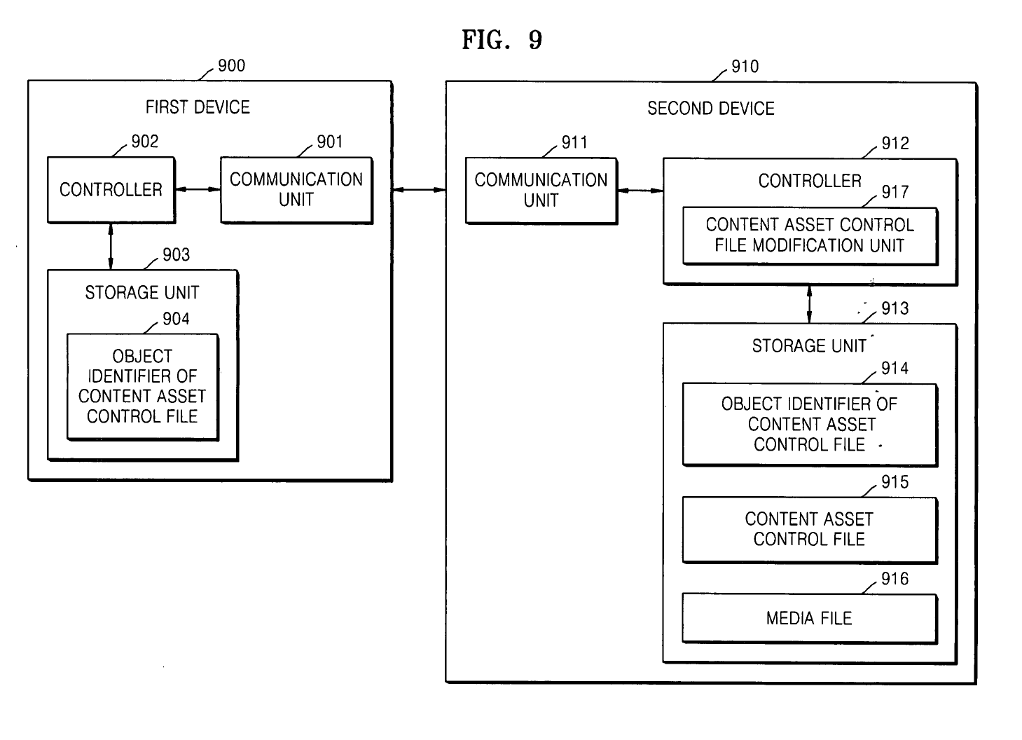

FIG. 9 illustrates a structure of a first device 900 and a second device 910 sharing content assets according to an exemplary embodiment of the present invention.

Referring to FIG. 9, the first device 900 operating as a picture transfer protocol (PTP) initiator includes a communication unit 901 that communicates with the second device 910 operating as a PTP responder, and a controller 902 that initiates a PTP operation for sharing a content asset. A storage unit 903 stores an object identifier 904 of a content asset control file 915 of the second device 910, that is to be shared. According to the present exemplary embodiment, the object identifier 904 for the content asset control file 915 is predetermined in the first device 900 and the second device 910. Although the object identifier 904 is stored in the storage unit 903 in FIG. 9, the present exemplary embodiment is not limited thereto, and it will be apparent to those of ordinary skill in the art that various methods can be employed. The controller 902 of the first device 900 receives information on the content asset control file 915 of the second device 910 or the content asset control file 915 itself by using the predetermined object identifier 904 without requesting a list of all object identifiers that can be provided by the second device 910.

The content asset control file 915 received by using the object identifier 904 includes content information contained in the content asset, and records access information on media files corresponding to respective contents. Although the content asset control file 915 may be an INDEX.PVM file that is a ROOT album file in compliance with the music photo video (MPV) standard, the present exemplary embodiment is not limited thereto. Thus, the content asset control file 915 may be a file for controlling another album or another type of content asset except for an album. The object identifier 904 for the ROOT album file is an ObjectHandle for the INDEX.PVM file.

Referring to FIG. 9, the second device 910 is a responder which provides the content asset control file 915 included in the second device 910 itself and media files 916 included in the content asset to the first device 900. The second device 910 includes a communication unit 911 which communicates with the first device 900, a storage unit 913 which stores object files including the content asset control file 915 and the media files 916, and a controller 912 which performs a PTP operation for providing the content asset control file 915 and the media files 916. The storage unit 913 records a predetermined object identifier 914 of the content asset control file 915 for the first device 900. The object identifier 914 is a unique identifier which is not used for other objects. When a request for the content asset control file 915, including the object identifier 914 of the content asset control file 915, is received from the first device 900, the controller 912 reads the content asset control file 915 from the storage unit 913. Thereafter, the controller 912 additionally records object identifiers for respective object files included in the content asset by using a content asset control file modification unit 917, and transmits the modified content asset control file 915 to the first device 900. The first device 900 may directly read a desired media file from the second device 910 by using an object identifier included in the modified content asset control file, that is, an ObjectHandle. As described above, the content asset control file 915 may be one or more album files including the INDEX.PVM file that is the ROOT album file.

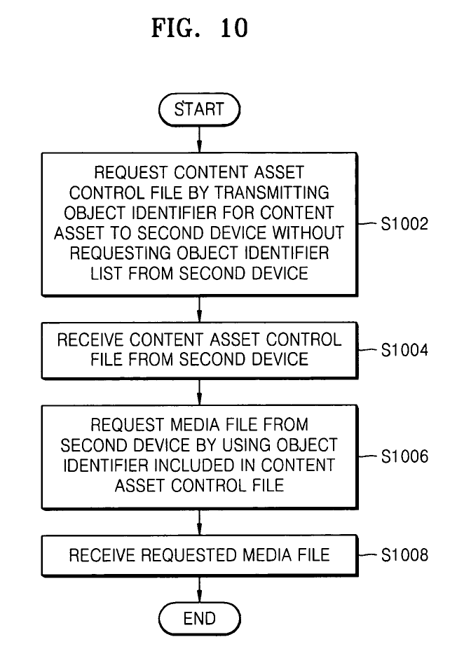

FIG. 10 is a flowchart illustrating a method of sharing content assets of the first device 900 and the second device 910 according to an exemplary embodiment of the present invention.

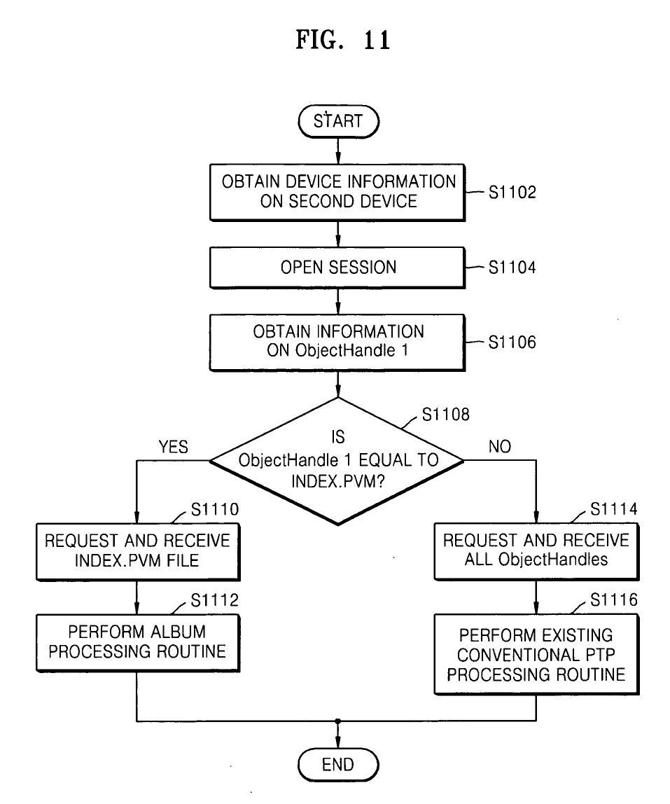

Referring to FIG. 10, when a session with the second device 910 is opened, the controller 902 of the first device 900 transmits an object identifier of the content asset to the second device 910, thereby requesting a content asset control file (operation S1002). Before the content asset control file is requested, object information on the object identifier may be requested and received and analyzed so that a process for checking whether an object corresponding to the object identifier is the content asset control file can be carried out. The checking process will be described in detail later with reference to FIG. 11. Next, the content asset control file is received from the second device 910 (operation S1004). Object identifiers for objects included in the content asset are recorded in the received content asset control file which has been modified by the second device 910. A desired media file is requested by the second device 910 by using the object identifiers. Then the requested media file is received (operation S1008).

FIG. 11 is a flowchart illustrating a method of recognizing a ROOT MPV album according to an exemplary embodiment of the present invention. Although the content asset control file is a ROOT album in FIG. 11, another type of content asset control file may also use a similar method.

Referring to FIG. 11, when two devices are connected to each other, the first device 900 requests and obtains device information on the second device 910 (operation S1102). Next, a PTP session is opened. (operation S1104). When the session is connected, object information is requested and obtained by considering a predetermined object identifier (for example, 1) as an ObjectHandle (operation S1106). The received object information is analyzed so as to determine whether its file name is INDEX.PVM (operation S1108). If an object allocated with the predetermined ObjectHandle is INDEX.PVM, an album file of INDEX.PVM is directly requested and received (operation S1110). An album processing routine is then carried out by using the received INDEX.PVM file (operation S1112). If the object allocated with the predetermined ObjectHandle is not the INDEX.PVM file, the second device 910 does not support an album sharing method according to the present invention. Thus, all ObjectHandles are requested and received according to the conventional art (operation S1114). Thereafter, a conventional art processing routine is carried out (operation S1116). Accordingly, the presence of the ROOT MPV album in the responder 910 can be rapidly and accurately determined.

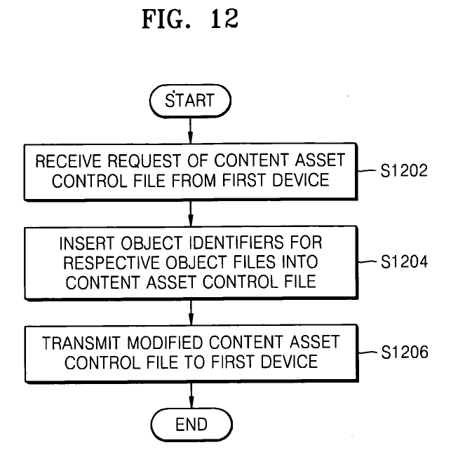

FIG. 12 is a flowchart illustrating a method of providing content assets from the second device 910 to the first device 900 according to an exemplary embodiment of the present invention.

Referring to FIG. 12, when the second device 910 receives a request for a content asset control file from the first device 900 (operation S1202), modification is carried out in which object identifiers of respective object files included in content assets are inserted into the content asset control file (operation S1204). Specifically, if an object to be transmitted is an album file, the second device 910 browses all <mpv:LastURL> elements before the album file is transmitted, and additionally records information including an ObjectHandle. Next, the modified content asset control file is transmitted to the first device 900 (operation S1206).

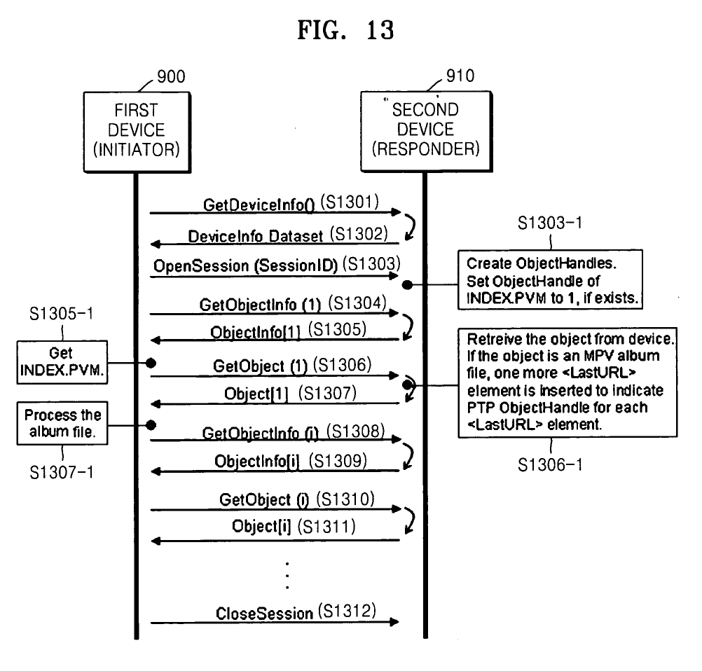

FIG. 13 illustrates an example of a PTP flow for sharing an MPV album according to an exemplary embodiment of the present invention. The MPV album proposed in the present exemplary embodiment can be properly transmitted by using PTP.

Referring to FIG. 13, in order to recognize an INDEX.PVM file existing in the ROOT directory, an ObjectHandle for the INDEX.PVM file is predetermined to be 1 (0x00000001) between an initiator 900 and a responder 910. In this case, the presence of a ROOT MPV album may be verified as illustrated in FIG. 11. Although it has been assumed that only one storage unit exists in the second device 910 acting as the responder in this exemplary embodiment, the present invention is not limited thereto. Thus, a structural feature of the present exemplary embodiment will also be used when a plurality of storages exist.

When the initiator 900 is connected to responder 910 using a USB connection or the like, the initiator 900 calls GetDeviceInfo( ) in order to obtain device information (operations S1301 and S1302). The initiator 900 calls OpenSession( ) in order to open a session (operation S1303). When the OpenSession( ) is received, the responder 910 allocates ObjectHandles to all files and folders included in a device (operation S1303-1). A ROOT directory and an ObjectHandle for the INDEX.PVM file existing in the ROOT directory are respectively allocated with 0x00000000 and 0x00000001. For the rest of the files and folders, any unique values can be allocated except for 0x00000000, 0x00000001, and 0xFFFFFFFF. When a session begins, the initiator 900 uses GetObjectInfo(1) to read ObjectInfo[1] which is object information having an ObjectHandle of 1 (operations S1304 and S1305). If the file name INDEX.PVM is included in the ObjectInfo[1], the ROOT MPV album exists in the responder 910. Otherwise, the INDEX.PVM file does not exist.

If the ROOT MPV album exists, a file of the ROOT MPV album is read (operation S1305-1). In this case, GetObject(1) is called (operation S1306). When GetObject( ) is called, the responder 910 checks whether the file has the extension “.PVM”, thereby checking whether the file is an album file. If an object that is to be transmitted to the initiator 900 is an MPV album, all <mpv:LastURL> elements are retrieved before the album file is transmitted, so that an additional <mpv:LastURL> element including the following ObjectHandle for the each existing <mpv:LastURL> element is inserted (operation S1306-1).

<mpv:LastURL mpv:filesystem=“PTP”>ObjectHandle</mpv: Last URL> mpv:filesystem=“PTP” denotes that an ObjectHandle is used in PTP. However, the present invention is not limited thereto, and other expressions may be used. The ObjectHandle denotes a media file's ObjectHandle. When the initiator 900 receives an album file modified in this way (operation S1307), ObjectHandles of respective media files included in an album can be determined. Thus, all media files or an album file included in the album can be read. That is, the initiator 900 refers to the modified album file so as to perform an album processing routine according to an exemplary embodiment of the present invention (operation S S1307-1). According to the album processing routine of the present exemplary embodiment, an ObjectHandle of a desired media file is read from the album file, and object information is requested (operation S1308). Then, the object information on the media file is received (operation S1309). Furthermore, transmission of the media file itself is requested and received (operations S1310 and S1311). When the album processing routine is completed, the session is closed (operation S1312).

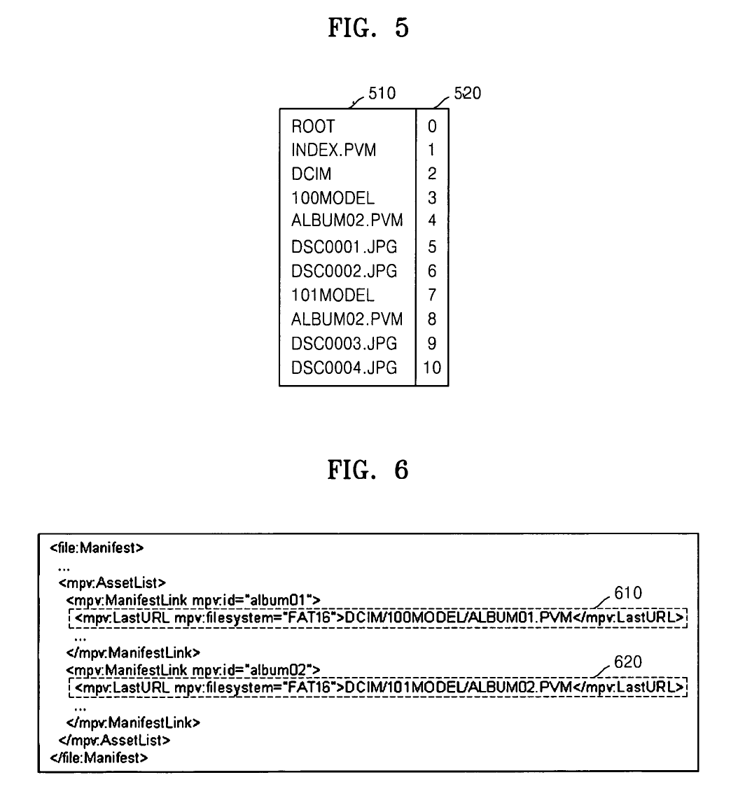

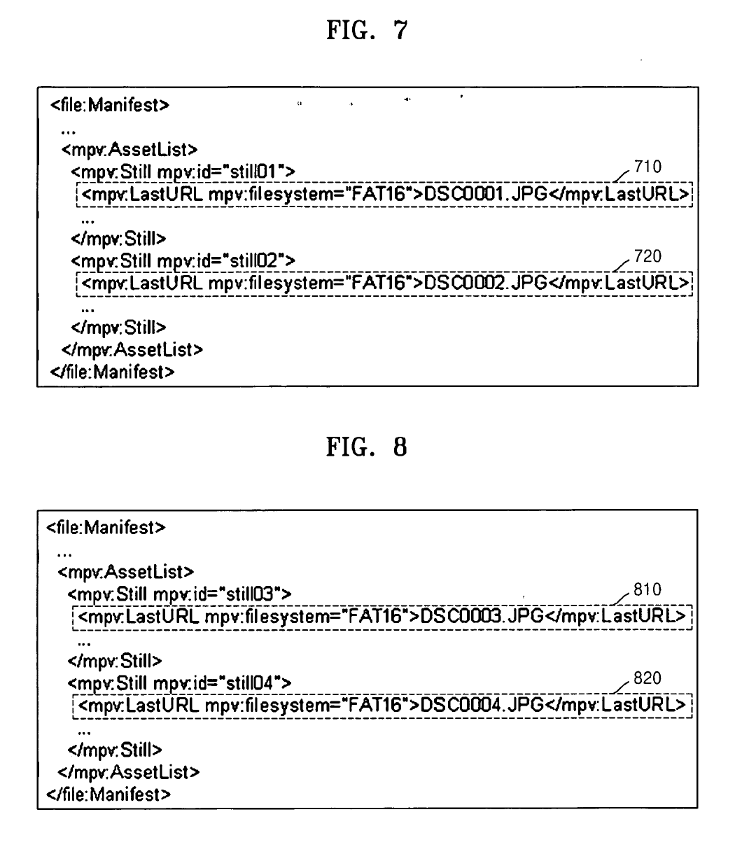

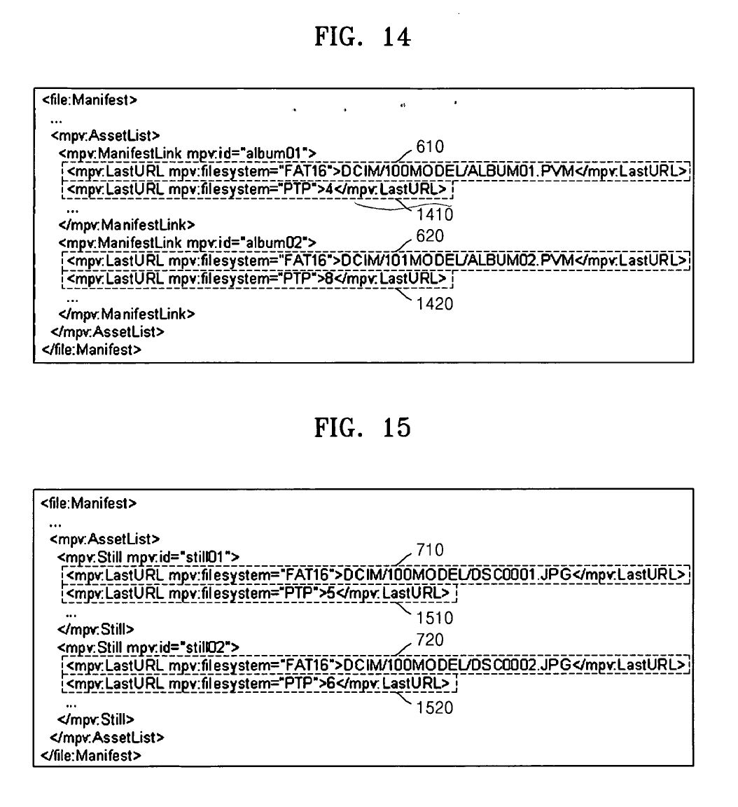

FIGS. 14, 15, and 16 respectively illustrate examples of files of INDEX.PVM, ALBUM01.PVM, and ALBUM02.PVM which have been modified according to an exemplary embodiment of the present invention. Contents included in the responder 910 are the same as shown in FIG. 4. When the responder 910 allocates an ObjectHandle as shown in FIG. 5, the album files of FIGS. 6, 7 and 8 are modified as shown in FIGS. 14, 15, and 16, respectively. Thereafter, the modified album files are transmitted to the initiator 900.

Referring to FIG. 14, in addition to an existing <mpv:LastURL> element 610 for the ALBUM01.PVM included in the INDEX.PVM, a <mpv:LastURL> element 1410 is inserted in order to write an ObjectHandle of 4. Likewise, in addition to an existing <mpv:LastURL> element 620 for the ALBUM02.PVM, a <mpv:LastURL> element 1420 is inserted in order to write an ObjectHandle of 8.

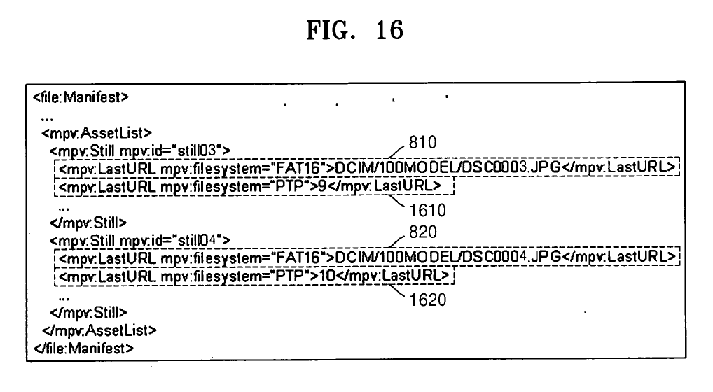

Referring to FIG. 15, in addition to an existing <mpv:LastURL> element 710 for the DSC0001.JPG included in the ALBUM01.PVM, an <mpv:LastURL> element 1510 is inserted in order to write an ObjectHandle of 5. Likewise, in addition to an existing <mpv:LastURL> element 720 for the DSC0002.JPG, a <mpv:LastURL> element 1520 is inserted in order to write an ObjectHandle of 6.

Referring to FIG. 16, in addition to an existing <mpv:LastURL> element 810 for the DSC0003.JPG included in the ALBUM02.PVM, an <mpv:LastURL> element 1610 is inserted in order to write an ObjectHandle of 9. Likewise, in addition to an existing <mpv:LastURL> element 820 for the DSC0004.JPG, a <mpv:LastURL> element 1620 is inserted in order to write an ObjectHandle of 10.

In the conventional art OSTA MPV specification, two or more <mpv:LastURL> elements are provided for one media asset. Thus, even if the album file is modified as described above, there is no problem in terms of compatibility. When the initiator 900 has to copy all the MPV albums to the initiator 900, the album file may be stored without modifying the <mpv:LastURL> element inserted by the responder 910, or the album file may be stored after removing the <mpv:LastURL> element. Even if the album file is stored without modification, conventional devices which are not compliant with this method will ignore a mpv:filesystem=“PTP” section. Thus, there is no problem in terms of operation.

According to the present invention, content assets can be simply and rapidly recognized without having to modify a standard for content assets such as a picture transfer protocol (PTP) or a music photo video (MPV) album. In addition, content sharing can be achieved in units of content assets. Thus, there is an advantage in that browsing, transferring, and operating can be carried out in units of content assets.

The invention can also be embodied, for example, as computer executable software instructions on a computer readable recording medium.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method in which a first device shares a content asset of a second device, the method comprising:
requesting a content asset control file by transmitting an object identifier for the content asset to the second device; and
receiving the content asset control file from the second device.

2. The method of claim 1, further comprising:
requesting object information on an object corresponding to the object identifier by transmitting the object identifier to the second device;
receiving the object information from the second device; and
determining whether the object is the content asset control file by analyzing the received object information, and deciding whether the content asset control file is requested based on a determination result.

3. The method of claim 2, further comprising requesting an object identifier list from the second device if the determination result shows that the object is not the content asset control file.

4. The method of claim 2, further comprising opening a picture transfer protocol (PTP) session with the second device before the object information is requested.

5. The method of claim 1, wherein the content asset is a Music Photo Video (MPV) ROOT album, and the object identifier is 1.

6. The method of claim 1, further comprising accessing a desired object file by using an object identifier for the desired object file included in the received content asset control file.

7. The method of claim 6, wherein the accessing of a desired object file further comprises:
reading the object identifier for the desired object file included in the received content asset control file; and
requesting the desired object file or information about the desired object file by transmitting the read object identifier to the second device.

8. The method of claim 6, wherein the received content asset control file is an MPV album file including an <mpv:LastUrl> element for writing an object identifier for each object file included in the content asset.

9. The method of claim 8, wherein the <mpv:LastUrl> element comprises a file system identifier which indicates that the object identifier is written.

10. A computer-readable medium having embodied thereon a computer program for executing a method in which a first device shares a content asset of a second device, the method comprising:
requesting object information by transmitting an object identifier for the content asset to the second device;
receiving the object information from the second device;
requesting a content asset control file by transmitting the object identifier to the second device when the received object information is analyzed and the object is determined to be the content asset control file;
receiving the content asset control file from the second device; and
accessing a desired object file by using an object identifier for one or more object files included in the received content asset control file.

11. A method of providing a content asset included in a second device to a first device, the method comprising:
receiving a request for a content asset control file from the first device;
modifying the content asset control file by recording an object identifier for each object file included in the content asset to the content asset control file; and
transmitting the modified content asset control file to the first device.

12. The method of claim 11, further comprising allocating an object identifier for a Music Photo Video (MPV) ROOT album file corresponding to the content asset control file when a Picture Transfer Protocol (PTP) session with the first device is opened.

13. The method of claim 12, wherein the object identifier is 1.

14. The method of claim 12, wherein the modifying of the content asset control file comprises inserting an <mpv:LastUrl> element including the object identifier for each object file into the content asset control file.

15. The method of claim 14, wherein the inserting of the <mpv:LastUrl> element comprises recording a file system identifier, which indicates that the <mpv:LastUrl> element writes the object identifier for each object file, in the <mpv:LastUrl> element.

16. A computer-readable medium having embodied thereon a computer program for executing a method of providing a content asset included in a second device to a first device, the method comprising:
receiving a request for a content asset control file from the first device;
modifying the content asset control file by recording object identifiers for respective object files included in the content asset into the content asset control file; and
transmitting the modified content asset control file to the first device.

17. An apparatus for sharing a content asset of a second device, the apparatus comprising:
a communication unit which communicates with the second device;
a storage unit which stores an object identifier for the content asset; and
a controller which receives a content asset control file through the communication unit by using the object identifier.

18. The apparatus of claim 17, wherein the controller requests and receives object information about an object corresponding to the object identifier by transmitting the object identifier to the second device, and analyzes the received object information so as to request the content asset control file from the second device if the object is the content asset control file, or to request a list of all object identifiers from the second device if the object is not the content asset control file.

19. The apparatus of claim 18, wherein the controller opens a Picture Transfer Protocol (PTP) session with the second device before the object information is requested.

20. The apparatus of claim 17, wherein the content asset is a Music Photo Video (MPV) ROOT album, and the object identifier is 1.

21. The apparatus of claim 17, wherein the controller accesses a desired object file by using an object identifier for the desired object file included in the received content asset control file.

22. The apparatus of claim 21, wherein the controller reads the object identifier for the desired object file from the received content asset control file, and requests the desired object file or information on the desired object file by transmitting the read object identifier to the second device.

23. The apparatus of claim 22, wherein the received content asset control file is an MPV album file including an <mpv:LastUrl> element for writing an object identifier for each object file included in the content asset.

24. The apparatus of claim 23, wherein the <mpv:LastUrl> element further comprises a file system identifier which indicates that the object identifier is written.

25. An apparatus for providing a content asset to a first device, the apparatus comprising:
a communication unit which communicates with the first device;
a storage unit which stores a content asset control file and at least one object file included in the content asset; and
a controller which transmits the content asset control file through the communication unit after reading the content asset control file from the storage unit and modifying the content asset control file by recording object identifiers for respective object files to the content asset control file when a request for the content asset control file is received from the first device through the communication unit.

26. The apparatus of claim 25, wherein the controller allocates an object identifier to a Music Photo Video (MPV) ROOT album file corresponding to the content asset control file when a Picture Transfer Protocol (PTP) session with the first device is opened.

27. The apparatus of claim 26, wherein the object identifier is 1.

28. The apparatus of claim 27, wherein the controller inserts <mpv:LastUrl> elements including object identifiers for respective object files into the MPV ROOT album file.

29. The apparatus of claim 28, wherein the controller records a file system identifier which indicates that the <mpv:LastUrl> elements write object identifiers for respective object files in the <mpv:LastUrl> element.
